(19) United States
(12) Patent Application Publication
(10) Pub. No.: US 2025/0102890 A1
(43) Pub. Date: Mar. 27, 2025

(54) LINEARLY-AIMED OPTICAL GIMBAL

(71) Applicant: The Charles Stark Draper Laboratory, Inc., Cambridge, MA (US)

(72) Inventors: Juha-Pekka J. Laine, Boston, MA (US); Peter A. Lewis, Sterling, VA (US)

(21) Appl. No.: 18/894,617

(22) Filed: Sep. 24, 2024

Related U.S. Application Data
(60) Provisional application No. 63/584,933, filed on Sep. 25, 2023.

(51) Int. Cl. G03B 17/56

(52) U.S. Cl. CPC G03B 17/561; G03B 17/565

(57) ABSTRACT

An optical gimbal system includes a mirror having a non-planar surface and a digital camera having an optical axis directed toward a portion of the non-planar surface to have the mirror fold the optical axis. A motor is mechanically coupled to the mirror, the digital camera, or both the mirror and the digital camera. The motor is configured to translate the mirror relative to the digital camera along at least one translation axis.

### CROSS-REFERENCE TO RELATED APPLICATIONS

This application claims the benefit of U.S. provisional application Ser. No. 63/584,933 filed Sep. 25, 2023, the disclosure of which is hereby incorporated in its entirety by reference herein.

### TECHNICAL FIELD

The present disclosure relates to optical gimbals and, more particularly, to optical gimbals for changing look directions.

### BACKGROUND

Most propelled and/or guided devices, such as vessels at sea, vehicles in air, on land, or in space (collectively referred to herein as vehicles), require information about their locations and/or attitudes to accomplish their missions. This information may be obtained from one or more sources, such as a global positioning system (GPS), ground-based radar tracking stations and/or on-board star trackers. Some vehicles include optical gimbals and digital cameras to make visual observations or collect data.

A star tracker is an optical device that measures bearing(s) to one or more stars, as viewed from a vehicle. A star tracker observes the stars via an aperture in the body of the vehicle. A star catalog lists bright navigational stars and information about their locations in the sky, sufficient for the star tracker to calculate its location in space, given bearings to several of the stars. A conventional star tracker includes a lens that projects an image of a star onto a photocell or that projects an image of one or more stars onto a light-sensitive sensor array (digital camera).

### SUMMARY

This section provides a general summary of the disclosure and is not a comprehensive disclosure of its full scope or all of its features.

In some aspects, the present disclosure is directed to an optical gimbal system including a mirror having a non-planar surface, and a digital camera having an optical axis directed toward a portion of the non-planar surface to have the mirror fold the optical axis. The optical gimbal system further includes a motor mechanically coupled to the mirror, the digital camera, or both the mirror and the digital camera. The motor is configured to translate the mirror relative to the digital camera along at least one translation axis.

In some aspects, the present disclosure is directed to an optical gimbal system that includes a mirror having a non-planar surface, a plurality of digital cameras, and a controller. Each digital camera has a respective optical axis directed toward a respective portion of the non-planar surface to have the mirror fold the respective optical axis in a respective different direction. Each digital camera is further configured to generate a respective image output signal. The controller is coupled to the plurality of digital cameras and configured to select one digital camera of the plurality of digital cameras in response to receipt of a direction request signal, and output the image output signal from the selected one digital camera.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 is a perspective view of a portion of an aircraft with an optical gimbal;

FIG. 2 is a close-up perspective view of the optical gimbal of FIG. 1:

FIG. 3 is a cut-away view of a conventional periscope;

FIG. 4 is a perspective view of a hypothetical box with a hole cut in it and placed over a top end of the periscope of FIG. 3;

FIG. 5 is a perspective and partially schematic view of an optical gimbal system, according to the present disclosure;

FIG. 6 is a side view of the optical gimbal system of FIG. 5, according to the present disclosure;

FIG. 7 is a top view of the optical gimbal system of FIG. 5. according to the present disclosure;

FIG. 8 is a perspective view of the optical gimbal system of FIG. 5 with a mirror of the optical gimbal system having been translated left of the position it is shown in FIG. 5, to the present disclosure;

FIG. 9 is a perspective and partially schematic view of an optical gimbal system, similar to the optical gimbal system of FIG. 5, except capable of translating the mirror along two translation axes, according to the present disclosure;

FIG. 10 is a perspective and partially schematic view of an optical gimbal system, similar to the optical gimbal systems of FIGS. 5 and 9, except capable of translating the mirror along three translation axes, according to the present disclosure;

FIG. 11A illustrates a perspective view of an example flat surface, in relation to potential shapes of a non-planar surface of the mirror of FIGS. 5-10, according to the present disclosure;

FIG. 11B illustrates a perspective view of an example single curved surface, in relation to potential shapes of a non-planar surface of the mirror of FIGS. 5-10, according to the present disclosure;

FIG. 11C illustrates a perspective view of an example double curved surfaces, in relation to potential shapes of a non-planar surface of the mirror of FIGS. 5-10, according to the present disclosure;

FIG. 11D illustrates a perspective view of an example double curved surface with inflection, in relation to potential shapes of a non-planar surface of the mirror of FIGS. 5-10, according to the present disclosure;

FIG. 12 is a side view of the optical gimbal system of FIG. 5, similar to that of FIG. 6, except with a convex double-curved surface of the mirror, according to the present disclosure;

FIG. 13 is a side view of the optical gimbal system of FIG. 5, similar to that of FIGS. 6 and 12, except with a concave double-curved surface of the mirror, according to the present disclosure;

FIG. 14 is a side view of the optical gimbal system of FIG. 5, similar to that of FIGS. 6, 12, and 13, except with an inflected double-curved surface of the mirror, according to the present disclosure;

FIG. 15 is a perspective and partially schematic view of an optical gimbal system, similar to the optical gimbal system of FIG. 5, except including a faceted mirror, according to the present disclosure;

FIG. 16 is a perspective and partially schematic view of an optical gimbal system, similar to the optical gimbal system of FIG. 5, except including multiple digital cameras, according to the present disclosure;

FIG. 17 is a top view of the optical gimbal system of FIG. 16, according to the present disclosure; and

FIG. 18 is a perspective view of a satellite space craft, including two conventional star trackers.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One type of star tracker is “strapped-down,” meaning its view angle, relative to its vehicle, is fixed. Another type of star tracker can be aimed mechanically, such as in a direction in which a navigational star is expected to be seen. Strapped-down star trackers are mechanically simpler than mechanically aimable star trackers. However, the fixed view angle of a strapped-down star tracker limits the number of navigational stars that may be used. A mechanically aimable star tracker can use a larger number of navigational stars. However, aiming a prior art star tracker, relative to its vehicle, can pose some issues, not least of which is rotating a mirror or prism in a conventional optical gimbal to direct the field of view of the sensor.

In some aspects, the present disclosure provides optical gimbals that may aim an optical sensor's field of view (FOV) within a larger field of regard (FOR), through a small aperture, without necessarily rotating an optical component. In some embodiments, a linear motor translates a curved mirror, such as a conical mirror, relative to a digital camera, to change the field of view of a digital camera. In some embodiments, a plurality of digital cameras is directed toward a curved mirror, and an output of one of the digital cameras is selected, depending on a desired look direction. In any embodiment, the curved mirror may be used to provide a selectable optical power, selectable by linearly translating the mirror. The mirror may be linearly translated more accurately, and with smaller components, than rotating a corresponding optical component in a conventional mechanically aimable star tracker.

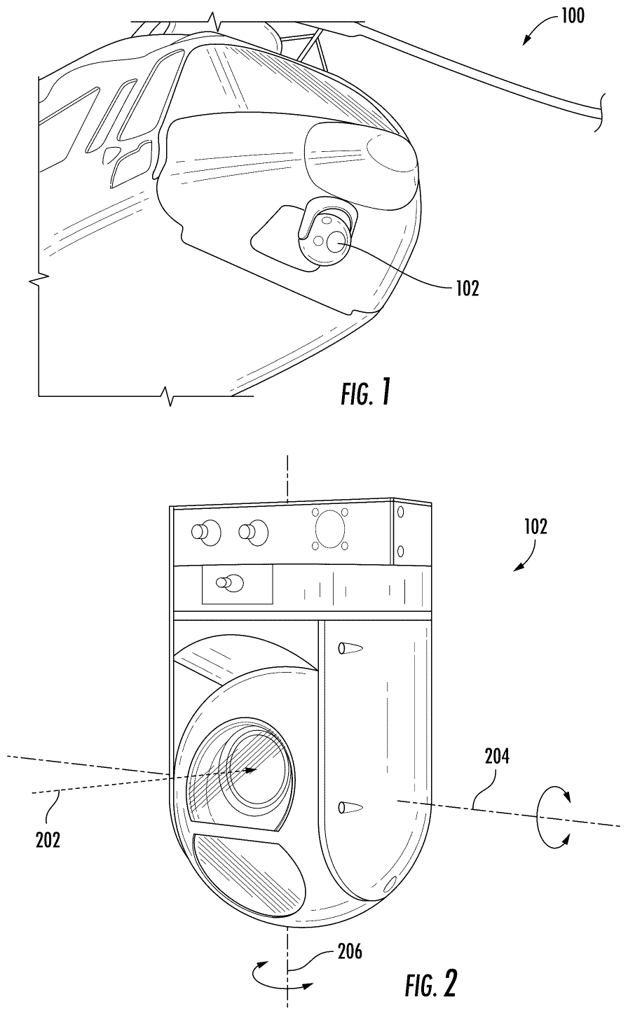

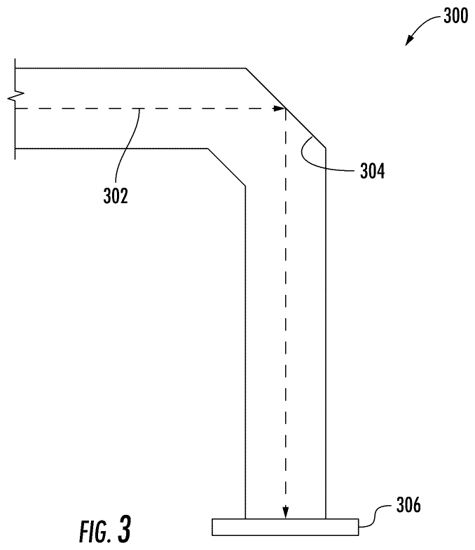

FIG. 1 is a perspective view of a portion of an aircraft 100 with a conventional optical gimbal 102, and FIG. 2 is a close-up perspective view of the optical gimbal 102. The optical gimbal 102 may include a digital camera (not visible) and can be used for surveillance, navigation, or another purpose. The optical gimbal 102 enables the digital camera to receive light 202 (FIG. 2) from a scene, more specifically from a look direction that depends on rotation angles of the gimbal 102 about two axes 204 and 206.

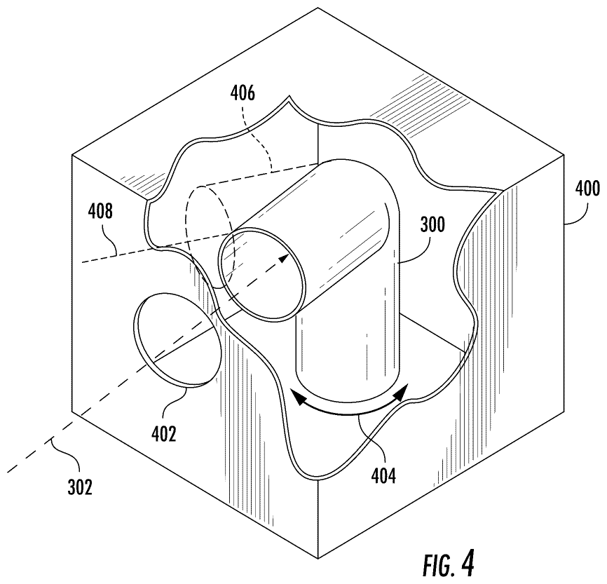

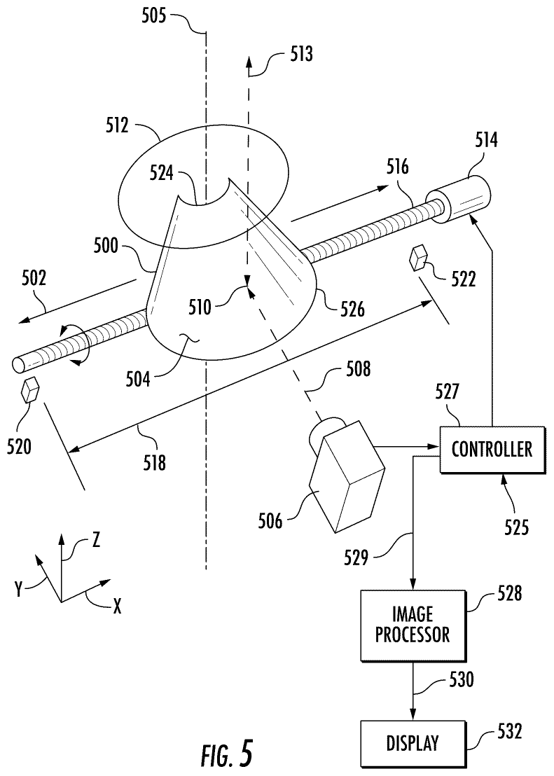

FIG. 18 is a perspective view of an exemplary space vehicle 1800 with two conventional star trackers 1802 and 1804. The space vehicle 1800 provides each star tracker 1802 and 1804 with a view of the sky via a respective aperture 1806 and 1808. If either or both of the star trackers 1802 and 1804 were conventional mechanically aimable star trackers, they would include optical gimbals, similar to the optical gimbal 102 shown in FIGS. 1 and 2. Each star tracker 1802 and 1804 has a respective field of regard that is limited by its respective aperture 1806 and 1808, as explained through the following analogy with reference to FIGS. 3 and 4.

FIG. 3 is a cut-away view of a conventional periscope 300, in which light 302 from a scene is folded by a mirror 304 and directed to a sensor 306. Disposing an optical gimbal behind an aperture is somewhat analogous to disposing a box 400 with a hole or aperture 402 cut in it over the top portion of a periscope 300, as shown in FIG. 4. The periscope 300 can rotate, as indicated by a double-headed arrow 404. However, the box 400 limits the field of regard of the periscope 300, as the periscope 300 rotates (e.g., arrow 404), because as the optical gimbal 200 rotates away from alignment with the aperture 402, as shown in dotted line 406, the periscope field of view is directed 408 toward the inside of the box 400.

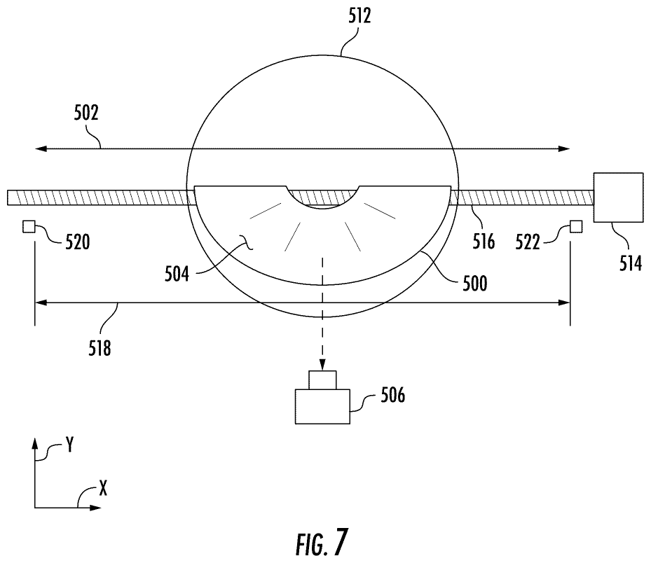

In one form, the present disclosure is believed to address one or more issues of aperture-limited field of regard for conventional optical gimbal-equipped systems, in part because most embodiments do not rotate any optical element to change the look direction. As detailed herein, some embodiments of the present disclosure linearly translate a non-planar mirror (e.g., mirror 500 of FIGS. 5 and 7 is linearly translated as indicated by a double-headed arrow 502 and may be referred to as a translation axis 502).

FIGS. 5, 6, and 7 are respective perspective, side, and top partially schematic views of an optical gimbal system, according to an embodiment of the present disclosure. The mirror 500 has a non-planar surface 504. In some embodiments, the non-planar surface 504 defines at least a portion of a conical surface. In such embodiments, the cone has an axis 505.

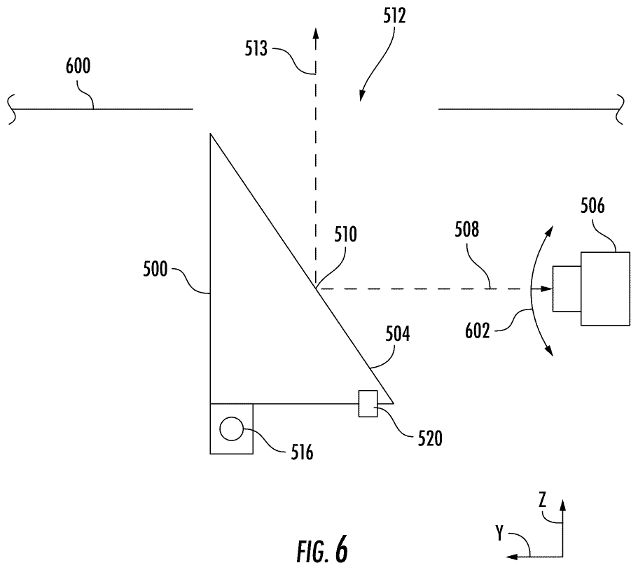

A digital camera 506 has an optical axis 508. Light enters the digital camera 506, as indicated by an arrowhead at the end of the optical axis 508. The optical axis 508 is directed toward a portion of the non-planar surface 504, such that the mirror 500 folds the optical axis 508, as indicated at 510 (e.g., “fold 510” or “fold point 510” hereinafter), through an aperture 512, such as an aperture defined by a housing 600 (FIG. 6), such as the shell of a space vehicle. As a result of this fold 510, the camera 506 has an effective look direction 513.

In this embodiment, the camera 506 is fixed in place. A motor 514 is mechanically coupled to the mirror 500. The motor 514 is configured to translate the mirror 500, relative to the camera 506, along at least one translation axis 502. For example, a nut or linear gear (not visible) may be rigidly attached to the mirror 500, and the motor 514 may animate a worm 516 that engages threads of the nut or teeth of the linear gear to translate the mirror 500 in either direction along the translation axis 502, depending on rotation direction of the motor 514. The translation axes 502 may be referred to as an x axis.

As in Euclidean geometry, a translation is a geometric transformation that moves every point of a figure, shape, or space by the same distance in a given direction. As in classical physics, translational motion is movement that changes the position of an object, as opposed to rotation.

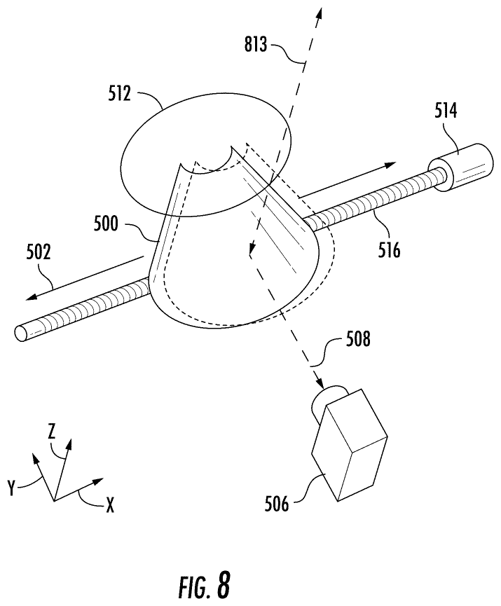

FIG. 8 shows the mirror 500 having been translated left of the position it is shown in FIG. 5. The new position of the mirror 500 results in a look direction 813 that is different from the look direction 513 caused by the former position of the mirror 500 (FIG. 5). The former position of the mirror 500 is shown in dotted line in FIG. 8.

Although FIGS. 5-8 show a fixed camera 506 and the motor 514 mechanically coupled to the mirror 500 to translate the mirror 500, in some other embodiments (not shown), the mirror 500 is fixed in place, and the motor 514 is mechanically coupled to the digital camera 506 to translate the camera 506 along the at least one axis 502. In either case, the motor 514 is configured to translate the mirror 500, relative to the camera 506, along the at least one translation axis 502. For simplicity of explanation, we refer to the motor 514 translating the mirror 500, but these explanations also apply, mutatis mutandis, to embodiments in which the motor 514 translates the camera 506. In any case, the motor 514 and worm 516 are considered to provide a first stage of the optical gimbal system.

The motor 514 is configured to translate the mirror 500, relative to the camera 506, within a predetermined translation range 518 (FIG. 5). Travel limit sensors 520 and 522 may enforce the predetermined translation range 518 and/or detect when the mirror travels beyond the predetermined translation range 518. The mirror 500 is configured to fold 510 the optical axis 508 through the aperture 512, for all mirror positions relative to the camera 506 within the predetermined translation range 518, given dimensions of the aperture 512, its position and orientation, relative to the mirror 500, position and orientation of the digital camera 506, and other readily ascertainable dimensions. Conventional or freeform optical design techniques can be used to generate or validate parameters of the optical components, such as shape and size of the mirror 500, given the other dimensions.

In some embodiments, the mirror 500 or the digital camera 506 may be allowed to translate further, outside the predetermined translation range 518, where the optical axis 508 of the camera 506 does not intersect the mirror surface 504, or the housing 600 blocks the optical axis 508. Nevertheless, there exists a predetermined translation range 518, within which the optical axis 508 of the camera 506 intersects the mirror surface 504 for all mirror positions, relative to the camera 506.

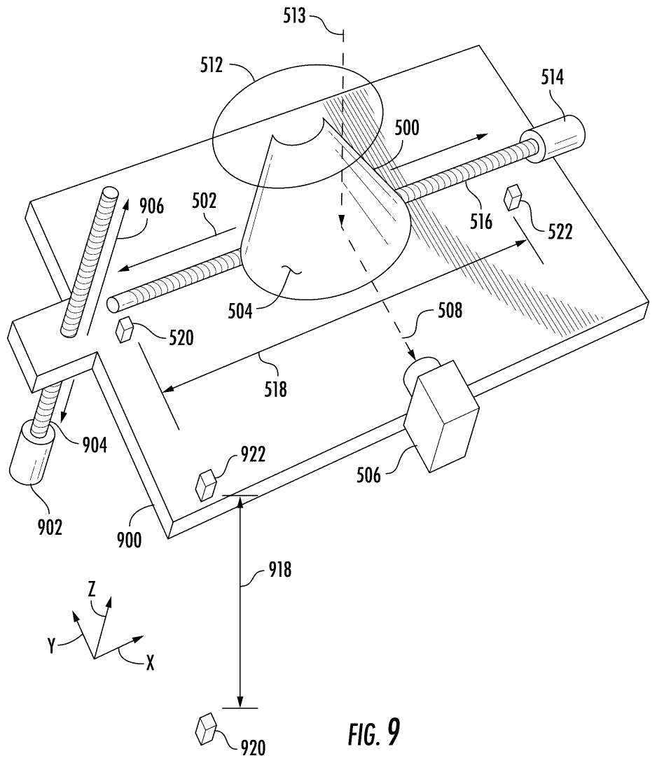

In some aspects, the mirror 500 is adapted to be translated along two different axes. In a non-limiting example, referring to FIG. 9, the motor 514 and the worm 516 are attached to a second stage 900, and the entire second stage 900 is translated by a second motor 902 and a second worm 904 along a second translation axis 906. Additional travel limit sensors 920 and 922 may enforce a predetermined translation range 918 and/or detect when the mirror 500 travels beyond the predetermined translation range 918. The digital camera 506 is fixed in place and does not move with either the second stage 900 or the mirror 500. Thus, the motors 514 and 902 are configured to translate the mirror 500, relative to the camera 506, along at least two translation axes 502 and 906. The two translation axes 502 and 906 may be referred to as x and z axes, respectively.

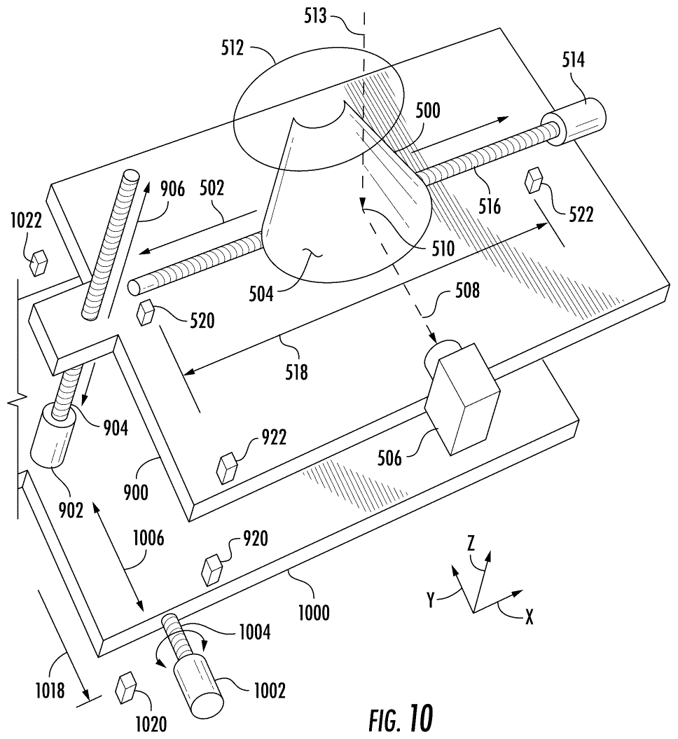

In some aspects, the mirror 500 is adapted to be translated along three different axes. In a non-limiting example, referring to FIG. 10, the motor 902 and the worm 904 are attached to a third stage 1000, and the entire third stage 1000 is translated by a third motor 1002 and a third worm 1004 along a third translation axis 1006. Additional travel limit sensors 1020 and 1022 may enforce a predetermined translation range 1018 and/or detect when the mirror 500 travels beyond the predetermined translation range 1018. The digital camera 506 is fixed in place and does not move with either the second stage 900, the third stage 1000, or the mirror 500. Thus, the motors 514, 902, and 1002 are configured to translate the mirror 500, relative to the camera 506, along at least three translation axes 502, 906, and 1006. The three translation axes 502, 906, and 1006 may be referred to as x, z, and y axes, respectively.

Translating a conical mirror 500 along the z axis (906) causes the digital camera 506 having the optical axis 508 to intersect the mirror 500 closer to, or further from, the base of the mirror 500 cone. This translation shifts the look direction 513 along the y-axis (1006). This translation also lengthens or shortens the optical path between the digital camera 506 and the scene, therefore adjusting the size of the field of view of the digital camera 506.

By including a selected subset of the stages, embodiments may be constructed that translate the mirror 500 along any one, two, or three of the translation axes 502, 906, and/or 1006 (x, z, and/or y). For example, an embodiment (not shown) may translate the mirror 500 along only the x (502) and y (1006) translation axes, and not along the z (906) translation axis.

As noted, in some embodiments, the non-planar surface 504 (FIG. 5) defines at least a portion of a conical surface. Such a conical surface is a curved surface, more specifically a single-curved surface. Referring again to FIG. 5, the nature of the single-curved surface 504, represented by shapes and dimensions of curves 524 and 526, dictates how the look direction 513 varies, as the mirror 500 is translated along the translation axis 502. The curvature of the surface 504 dictates optical power of the mirror 500. The curvature, and therefore the optical power, need not necessarily be the same at all points on the surface 504 of the mirror 500. Thus, the optical power can vary, as the mirror 500 translates along the translation axis 502.

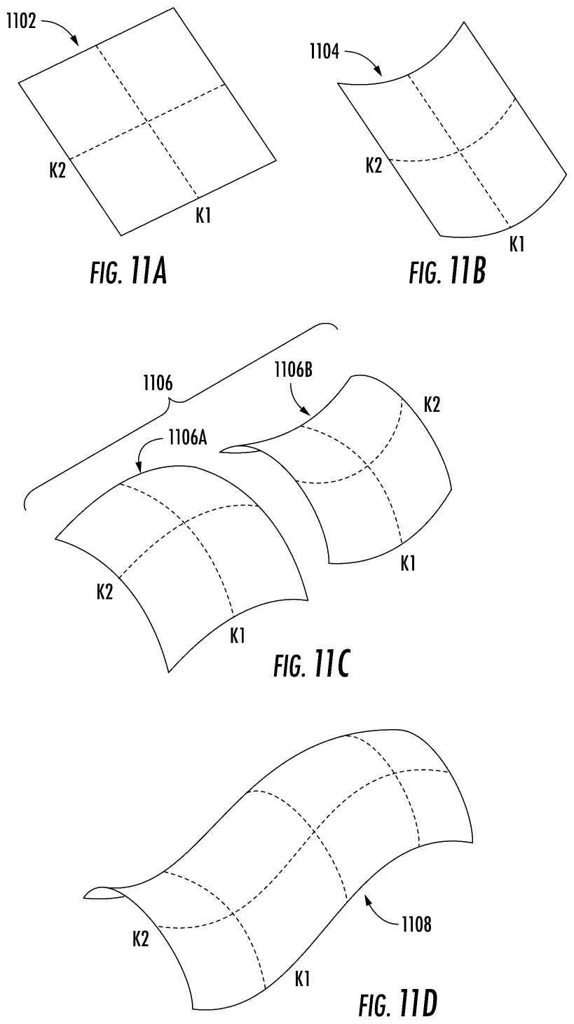

In the embodiments described with reference to FIGS. 5-10, the mirror 500 surface 504 is a single-curved surface. However, in other embodiments, the non-planar surface 504 may define other curved surfaces, including other single-curved surfaces, as well as double-curved surfaces and more complex curved surfaces, such as curved surfaces with inflections. Some non-limiting examples of curved surfaces are shown in FIGS. 11A, 11B, 11C, and 11D, in which Gaussian curvature measurements are used to describe curved surfaces. Gaussian curvature (K) of a surface at any given point is the product of the principal curvatures in each direction: K=k₁×k₂. For example, FIG. 11A illustrates a flat surface 1102 in which k1=0 and k2=0); FIG. 11B illustrates a single curved surface 1104 in which k1=0 and k2>0; FIG. 11C illustrates double curved surfaces 1106 having 1106A (k1>0, k2>0) and 1106B (k1<0, k2<0); and FIG. 11D illustrates a double curved surface with inflection 1108.

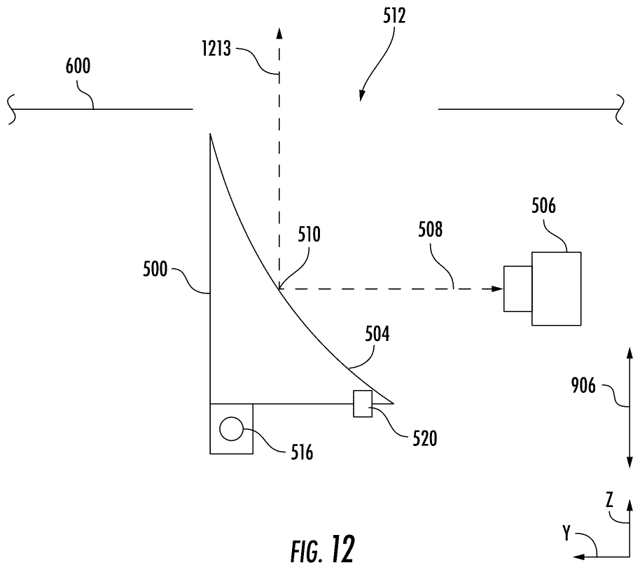

FIG. 12 is a side view of another embodiment of the optical gimbal system, similar to that of FIG. 6, except with a double-curved surface 504. Translating the mirror 500 along the z translation axis (906) moves the point fold 510 at which the optical axis 508 intersects the mirror surface 504, i.e., the point at which the mirror 500 folds the optical axis 508. Because the angle of the mirror surface 504 at the fold point 510 varies with position of the mirror 500, relative to the digital camera 506, along the translation axis 906, the look direction 1213 and the optical power vary with the position of the mirror 500, relative to the digital camera 506, along the translation axis 906.

Note that using a double-curved surface 504 provides more freedom in changing the look direction 1213 than using a single-curved surface 504. A double-curved surface 504 provides two degrees of freedom, i.e., translation axes 502 and 906, in selecting the look direction 1213 and optical power.

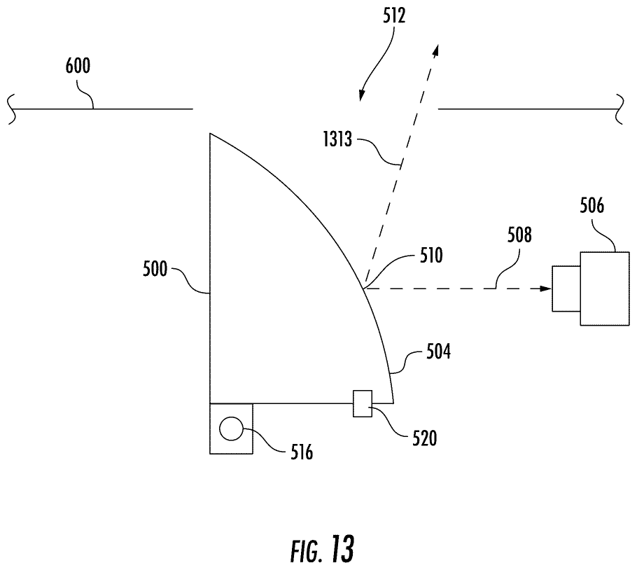

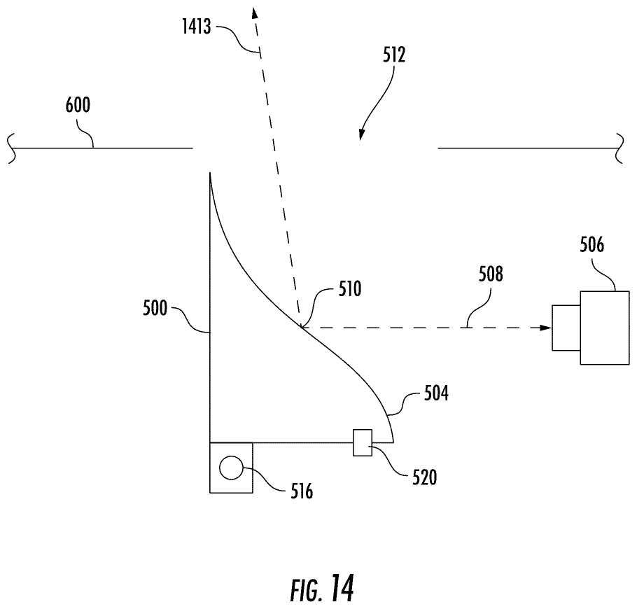

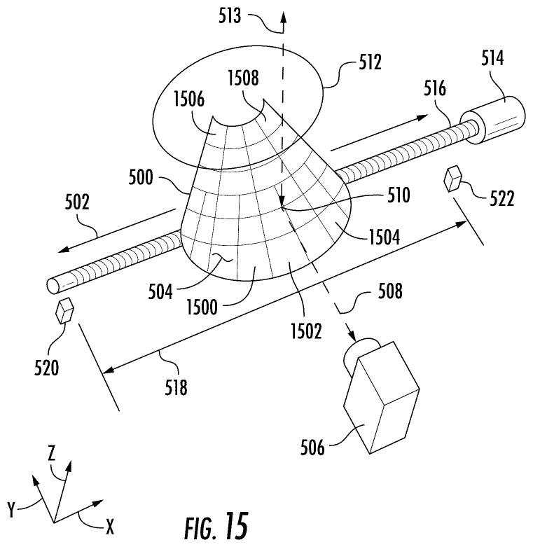

The curved surface 504 shown in FIG. 12 is concave along the translation axis 906. However, in other embodiments, the curved surface 504 is convex along the translation axis 906, for example as shown in FIG. 13, or more complex, for example including an inflection, as shown in FIG. 14.

In some embodiments, the non-planar surface 504 defines other curved shapes. For example, the curved mirror surface 504 may be configured to provide a monotonically or a non-monotonically varying optical power to the digital camera 506 along the at least one translation axis 502. The curved mirror surface 504 may be configured to provide an optical power that varies as a first function of translation distance along a one translation axis 502, 906, or 106. The curved mirror surface 504 may be configured to provide an optical power that varies as a second function, different from the first function, of translation distance along a second translation axis 502, 906, or 106, different from the first translation axis.

Although the embodiment described with reference to FIGS. 5-10 has a symmetric right conical mirror 500, in other embodiments, the mirror 500 can be oblique and/or non-symmetric along any translation axis 502, 906, and/or 106.

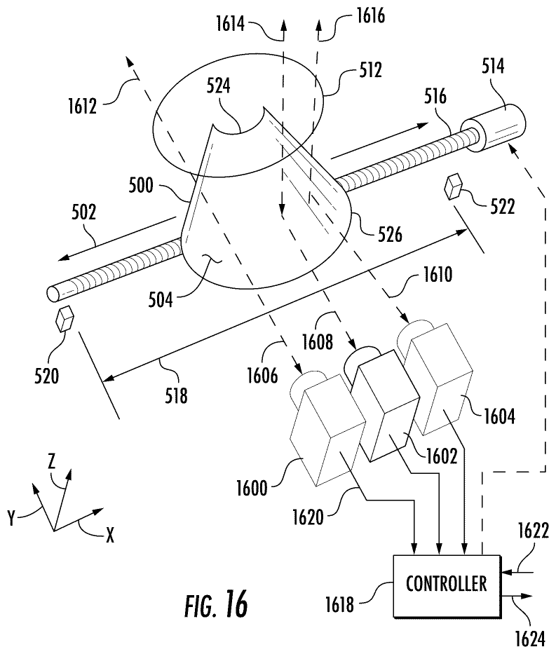

Some embodiments described herein have smooth mirrors 500, i.e., mirrors 500 in which surface angles vary smoothly, without discontinuities in their respective first derivatives. However, in other embodiments, as shown in FIG. 15, the mirror surface 504 includes a plurality of facets, exemplified by facets 1500, 1502, 1504, 1506, and 1508. In such embodiments, each facet 1500-1508 is planar, whereas in other embodiments, some, or all of the facets 1500-1508 are non-planar. Descriptions provided herein, relative to mirror surface(s), apply to each non-planar facet 1500, 1502, 1504, 1506, and 1508. Although the embodiment shown in FIG. 15 translates the mirror 500 along only one axis 502, other faceted mirror embodiments translate the mirror along two or three axes 502, 906, and/or 1006, as described herein.

The digital camera 506 may have a field of view sufficiently large to simultaneously image at least two facets of the plurality of facets 1500, 1502, 1504, 1506, and/or 1508, for all mirror positions relative to the digital camera 506 within the predetermined translation range 518. On the other hand, the digital camera 506 may have a field of view that simultaneously images at most one facet 1500, 1502, 1504, 1506, or 1508 of the plurality of facets 1500, 1502, 1504, 1506, and 1508, for all mirror positions relative to the digital camera 506 within the predetermined translation range 518.

The mirror 500 may be fabricated from any suitable material. For example, the mirror 500 may be fabricated from a block of optical glass machined to a desired shape and coated with a suitable reflective material, such as aluminum or gold.

Alternatively, the mirror 500 or facets thereof may be implemented with one or more deformable mirrors or MEMS mirrors.

In embodiments in which the mirror surface 504 defines at least a portion of a cone, the axis of the cone need not necessarily be perpendicular to the optical axis 508. The axis of the cone can be oriented in any desired direction to obtain a desired range of look directions 513, 813, 1213, 1313, or 1413.

Although linear translation of the mirror 500 is described as being performed by a worm drive, any suitable linear motor may be used, such as an electromagnetic linear motor, electrostatic linear motor, or pneumatic linear motor.

With continuing reference to FIG. 5, a controller 527 is coupled to each motor 514 (including motors 902 and/or 1002 of FIGS. 9 and 10). The controller 527 receives a direction request signal 525 from an external source (not shown). The direction request signal 525 indicates to the controller 527 a desired look direction, such as 513 (or 813 of FIG. 8). In response to receipt of the direction request signal 525, the controller 527 commands one or more of the motors 514 (if applicable, motors 902 and/or 1002) to translate the mirror 500 to a position that enables the digital camera 506 to capture an image from the desired look direction, based on shape and size of the mirror 500, position of the digital camera 506, relative to the mirror 500, etc. The controller 527 outputs an image signal 529 from the digital camera 506.

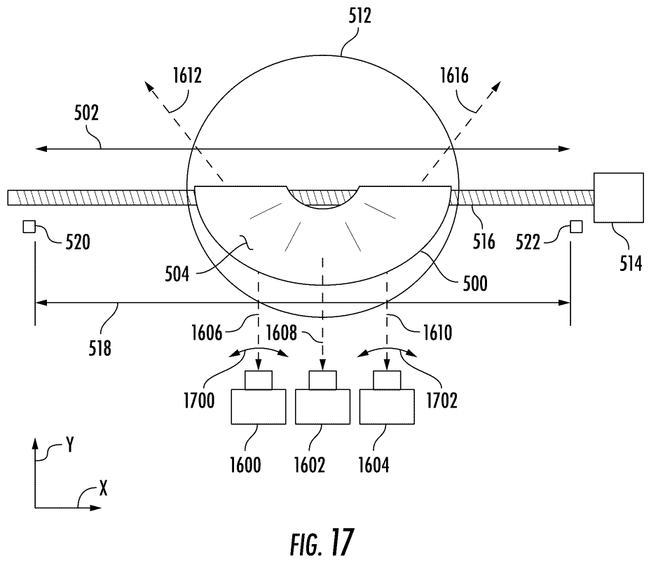

Referring to FIG. 16, instead of, or in addition to, translating the mirror 500 or the digital camera 506, some embodiments employ multiple digital cameras 1600, 1602, and 1604. While FIG. 16 shows three digital cameras 1600-1604, any suitable number of digital cameras can be used. In one such embodiment, optical axes 1606, 1608, and 1610 of the respective digital cameras 1600-1604 are parallel to each other, as shown in FIG. 16. Each optical axis 1606-1010 intersects with the mirror 500 at a different respective location on the mirror surface 504 and is, therefore, folded toward a different respective look direction 1612. 1614, and 1616.

A controller 1618 is coupled to each of the digital cameras 1600-1604, as exemplified by signal line 1620. The controller 1618 receives a direction request signal 1622 from an external source (not shown). The direction request signal 1622 indicates to the controller 1618 a desired look direction, such as 1612, 1614, or 1616. In response to receipt of the direction request signal 1622, the controller 1618 selects one of the digital cameras 1600-1604 that would capture an image from the desired look direction, based on shape and size of the mirror 500, position of the digital cameras 1600-1604, relative to the mirror 500, etc. The controller 1618 outputs an image signal 1624 from the selected digital camera 1600, 1602, or 1604.

Each digital camera 1600-1604 may have a respective identifier, such as an identifier that indicates the respective digital camera's location, relative to the other digital cameras 1600-1604. For example, various identifiers may indicate the locations of the digital cameras 1600-1604 along the x-axis 502, particularly in embodiments that do not translate the digital cameras 1600-1604 along the x-axis 502. As an analog of the location of a digital camera 1600-1604, the identifier also indicates where on the mirror surface 504 the mirror 500 folds an optical signal into the digital camera and, therefore, a power applied by the mirror 500 to the optical signal.

In embodiments that employ multiple digital cameras 1600-1604 and also translate the mirror 500 and/or the digital cameras 1600-1604, the controller 1618 also controls operation of the motor 514 or, in embodiments that have multiple translation axes, the multiple motors. In these embodiments, the controller 1618 translates the mirror 500, if necessary, and selects one of the digital cameras 1600, 1602, or 1604, based on the direction request signal 1622, i.e., the desired look direction. Although FIG. 16 shows the digital cameras 1600-1604 arranged parallel to the translation axis 502, in some embodiments, the digital cameras 1600-1604 may be arranged along an axis different from the translation axis 502 or multiple translation axes.

In the embodiment shown in FIG. 16, the digital cameras 1600-1604 are arranged parallel to the x-axis, although the digital cameras 1600-1604 can be arranged parallel any of the axes x, z, or y, or along an arbitrary line, or they can be arranged in a non-linear pattern. For example, the digital cameras 1600-1604 may be arranged in a two-dimensional pattern.

In the embodiment shown in FIG. 16, the digital cameras 1600-1604 are arranged such that their respective optical axes 1606-1610 are parallel to each other. However, in other such embodiments (not shown), the digital cameras 1600-1604 are arranged such that their respective optical axes 1606-1610 are not parallel to each other.

Although embodiments that translate either the mirror 500 or the camera(s) 506 or 1600-1604 have been described, other contemplated embodiments (not shown) translate both the mirror 500 and the camera(s) 506 or 1600-1604 to change the look direction 513 or 1213, 1313, or 1413, 1612-1616.

Although embodiments that linearly translate the mirror 500 and/or the camera(s) 506 or 1600-1604 have been described, some contemplated embodiments tilt one or more of the camera(s) 506 or 1600-1604 in the y-z plane, relative to the mirror 500, as indicated by double-headed arrow 602 (FIG. 6). In some embodiments, the mirror 500 tilts (not shown) in the y-z plane, relative to the camera(s) 506 or 1600-1604.

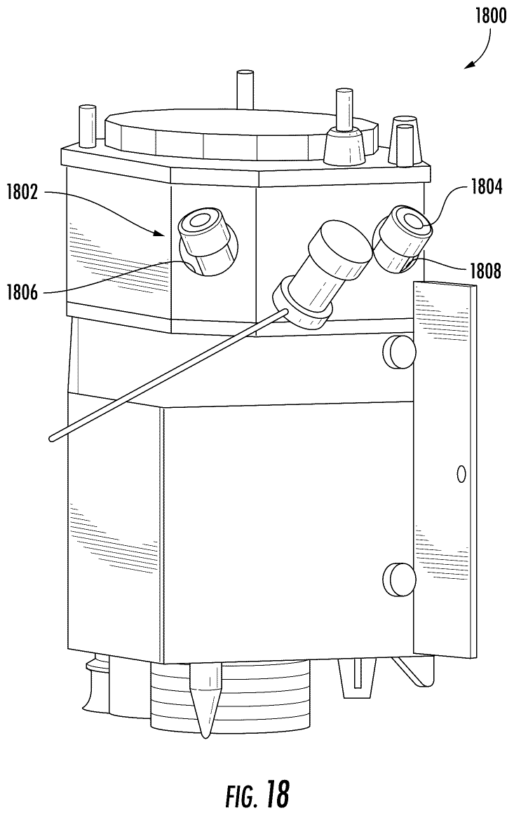

In some embodiments, one or more of the digital camera(s) 506 or 1600-1604 pivot in the x-y plane, for example as indicated by double-headed arrows 1700 and 1702 (FIG. 17).

The non-planar mirror 500 creates a geometrically distorted image. Optionally, an image processor 528 (FIG. 5) is configured to correct the distorted image and generate a corrected image signal 530. Given parameters of the mirror 500, distance between the digital camera 506 and the mirror 500, and orientation of the digital camera 506, relative to the mirror 500, the geometric distortion may be calculated and corrected using conventional techniques. Thus, the corrected image signal 530 may be fed to a display device 532 for viewing by a human operator.

Embodiments of the present disclosure may be used to perform imaging from within confined spaces and through small apertures. For example, the optical gimbal system of the present disclosure provide approximately 90° views without rotating an external container, as well as in other contexts.

As used herein, the following term shall have the following meanings, unless context indicated otherwise.

Field of regard (“FOR”) is the total area that can be captured by a movable sensor. FOR is distinct from field of view (“FOY”), which is the angular cone perceivable by the sensor at a particular time instant. In contrast, the field of regard is the total area that a sensing system can perceive by pointing the sensor, which is typically much larger than the sensor's FOY. For a stationary sensor, the FOR and FOY coincide.

“Continually” means continuously or repeatedly, although not necessarily in perpetuity. The term continually encompasses periodically and occasionally. Continually generating a signal means generating a continuously varying signal over time or generating a series of (more than one) discrete signals over time. Continually generating a value, such as an error value, means generating a continuously varying value, such as an analog value represented by a continuously varying voltage, or generating a series of (more than one) discrete values over time, such as a series of digital or analog values.

Star trackers, according to the present disclosure, may be used without resort to global positioning systems (GPS) or ground-based tracking systems. Therefore, these star trackers find utility in OPS-denied environments, among other contexts.

While the features of the present disclosure are described through the above-described example embodiments, modifications to, and variations of, the illustrated embodiments may be made without departing from the inventive concepts disclosed herein. For example, although specific parameter values, such as materials and dimensions, may be recited in relation to disclosed embodiments, within the scope of the present disclosure, the values of all parameters may vary over wide ranges to suit different applications. Unless otherwise indicated in context, or would be understood by one of ordinary skill in the art, terms such as “about” mean within ±20%.

As used herein, including in the claims, the term “and/or,” used in connection with a list of items, means one or more of the items in the list, i.e., at least one of the items in the list, but not necessarily all the items in the list. As used herein, including in the claims, the term “or” used in connection with a list of items, means one or more of the items in the list, i.e., at least one of the items in the list, but not necessarily all the items in the list. “Or” does not mean “exclusive or.”

As used herein, including in the claims, an element described as being configured to perform an operation “or” another operation is met by an element that is configured to perform only one of the two operations. That is, the element need not be configured to operate in one mode in which the element performs one of the operations, and in another mode in which the element performs the other operation. The element may, however, but need not, be configured to perform more than one of the operations.

Although aspects of embodiments may be described with reference to flowcharts and/or block diagrams, functions, operations, decisions, etc. of all or a portion of each block, or a combination of blocks, may be combined, separated into separate operations, or performed in other orders. References to a “module,” “operation,” “step” and similar terms are for convenience and not intended to limit their in1plementation. All or a portion of each block, module, operation, step, or combination thereof may be implemented as computer program instructions (such as software), hardware (such as combinatorial logic, Application Specific Integrated Circuits (ASICs), Field-Progran1mable Gate Arrays (FPGAs), processor or other hardware), firmware or combinations thereof.

The controller, image processor, etc. or portions thereof may be implemented by one or more suitable processors executing, or controlled by, instructions stored in a memory. Each processor may be a general-purpose processor, such as a central processing unit (CPU), a graphic processing unit (GPU), digital signal processor (DSP), a special purpose processor, etc., as appropriate, or combination thereof.

The memory may be random access memory (RAM), read-only memory (ROM), non-volatile memory (NVM), non-volatile random access memory (NVRAM), flash memory or any other memory, or combination thereof, suitable for storing control software or other instructions and data. Instructions defining some of the functions of the optical gimbal system of the present disclosure may be delivered to a processor in many forms, including, but not limited to, information permanently stored on tangible non-transitory non-writable storage media (e.g., read-only memory devices within a computer, such as ROM, or devices readable by a computer I/O attachment, such as CD-ROM or DVD disks), information alterably stored on tangible non-transitory writable storage media (e.g., floppy disks, removable flash memory and hard drives) or information conveyed to a computer through a communication medium, including wired or wireless computer networks. Moreover, while embodiments may be described in connection with various illustrative contexts, data structures, database schemas and the like, systems may be used in other contexts and they may be embodied using a variety of data structures, schemas, etc.

Disclosed aspects, or portions thereof, may be combined in ways not listed herein and/or not explicitly claimed. For example, a tilting digital camera 506, as described with reference to FIG. 6, may be employed in the embodiments described with reference to FIGS. 9, 10, and 12-16. In another example, in an embodiment that includes a plurality of digital cameras 1600-1604 (as described with reference to FIG. 16) and in which the mirror surface 504 includes a double-curved surface (as described with reference to FIGS. 12 and 13), the motor 902 and/or 1002 can be configured to translate the mirror 500, relative to the plurality of digital cameras 1600-1604, along at least one translation axes, such as the z or y axis 906 and/or 1006. In addition, embodiments disclosed herein may be suitably practiced, absent any element that is not specifically disclosed herein. Accordingly, the feature of the present disclosure should not be viewed as being limited to the disclosed embodiments.

As used herein, numerical terms, such as “first,” “second” and “third,” are used to distinguish respective elements, such as stages, translation axes, motors, etc. from one another and are not intended to indicate any particular order or total number of such elements in any particular embodiment. Thus, for example, a given embodiment may include only a second stage, second translation axis, and second motor.

What is claimed is:

1. An optical gimbal system comprising:
a mirror having a non-planar surface;
a digital camera having an optical axis directed toward a portion of the non-planar surface to have the mirror fold the optical axis; and
a motor mechanically coupled to the mirror, the digital camera, or both the mirror and the digital camera, and the motor being configured to translate the mirror relative to the digital camera along at least one translation axis.

2. The optical gimbal system of claim 1, wherein the motor is configured to translate the mirror relative to the digital camera within a predetermined translation range to have, for all mirror positions relative to the digital camera within the predetermined translation range, the optical axis of the digital camera intersect a surface of the mirror.

3. The optical gimbal system of claim 2, further comprising a housing that defines an aperture, wherein the mirror is configured to fold the optical axis through the aperture, for all mirror positions relative to the digital camera within the predetermined translation range.

4. The optical gimbal system of claim 1, wherein the surface of the mirror defines at least a portion of a conical surface.

5. The optical gimbal system of claim 1, wherein the surface of the mirror is curved.

6. The optical gimbal system of claim 5, wherein the surface of the mirror is configured to provide a monotonically varying optical power to the digital camera along the at least one translation axis.

7. The optical gimbal system of claim 5, wherein the surface of the mirror is configured to provide a non-monotonically varying optical power to the digital camera along the at least one translation axis.

8. The optical gimbal system of claim 1, wherein a surface of the mirror comprises a single-curved surface.

9. The optical gimbal system of claim 1, wherein a surface of the mirror comprises a double-curved surface and the motor is configured to translate the mirror relative to the digital camera along at least two translation axes.

10. The optical gimbal system of claim 9, wherein the motor is configured to translate the mirror relative to the digital camera along at least three translation axes.

11. The optical gimbal system of claim 9, wherein the surface of the mirror is configured to provide an optical power that varies as a first function of translation distance along a first translation axis of the at least two translation axes.

12. The optical gimbal system of claim 11, wherein the surface of the mirror is configured to provide an optical power that varies as a second function, different from the first function, of translation distance along a second translation axis, different from the first translation axis, of the at least two translation axes.

13. The optical gimbal system of claim 1, wherein:
a surface of the mirror defines a plurality of facets, and
the motor is configured to translate the mirror, relative to the digital camera, within a predetermined translation range to have, for all mirror positions relative to the digital camera within the predetermined translation range, the optical axis of the digital camera intersect the surface of the mirror.

14. The optical gimbal system of claim 13, wherein the digital camera has a field of view sufficiently large to simultaneously image at least two facets of the plurality of facets, for all mirror positions relative to the digital camera within the predetermined translation range.

15. The optical gimbal system of claim 13, wherein the digital camera has a field of view that simultaneously images at most one facet of the plurality of facets, for all mirror positions relative to the digital camera within the predetermined translation range.

16. An optical gimbal system comprising:
a mirror having a non-planar surface;
a plurality of digital cameras, wherein each digital camera:
has a respective optical axis directed toward a respective portion of the non-planar surface to have the mirror fold the respective optical axis in a respective different direction; and
is configured to generate a respective image output signal; and
a controller coupled to the plurality of digital cameras and configured to:
select one digital camera of the plurality of digital cameras in response to receipt of a direction request signal; and
output the image output signal from the selected one digital camera.

17. The optical gimbal system of claim 16, further comprising a housing that defines an aperture, wherein the mirror is configured to fold the optical axis through the aperture, for all digital cameras of the plurality of digital cameras.

18. The optical gimbal system of claim 16, wherein a surface of the mirror is curved.

19. The optical gimbal system of claim 18, further comprising a motor mechanically coupled to the mirror, the plurality of digital cameras, or both the mirror and the plurality of cameras, and the motor being configured to translate the mirror, relative to the plurality of digital cameras, along at least one translation axis.

20. The optical gimbal system of claim 19, wherein the surface of the mirror is configured to provide one of: a monotonically varying optical power to the plurality of digital cameras along the at least one translation axis, or a non-monotonically varying optical power to the plurality of digital cameras along the at least one translation axis.
